(19) United States
(12) Patent Application Publication
(10) Pub. No.: US 2024/0324524 A1
(43) Pub. Date: Oct. 3, 2024

(54) METHOD, APPARATUS AND SYSTEM FOR MUSHROOM PICKING

(71) Applicant: UNIVERSITY OF LINCOLN, Lincoln, Lincolnshire (GB)

(72) Inventors: Bashir Ibrahim AL-DIRI, Lincoln (GB); Khaled Ahmed ELGENEIDY, Lincoln (GB); Jason Grant BURGON, Lincoln (GB); Simon PEARSON, Lincoln (GB)

(73) Assignee: UNIVERSITY OF LINCOLN, Lincoln, Lincolnshire (GB)

(21) Appl. No.: 18/577,788

(22) PCT Filed: Jul. 18, 2022
(86) PCT No.: PCT/GB2022/051850

§ 371 Date: Jan. 9, 2024

(30) Foreign Application Priority Data
Jul. 20, 2021 (GB) 2110415.3

(51) Int. Cl. A01G 18/70; A01D 46/30

(52) U.S. Cl. CPC A01G 18/70; A01D 46/30

(57) ABSTRACT

A method for harvesting mushrooms which grow in clusters, by determining a picking schedule that maximises the yield while minimising damage to the mushroom or surrounding mushrooms to thereby increase shelf-life.

### FIELD

The present techniques generally relate to a system, apparatus and method for mushroom picking. In particular, the present techniques provide a method for harvesting mushrooms which grow in clusters.

### BACKGROUND

The mushroom production market in the UK is worth hundreds of millions of pounds. Mushrooms for retail (e.g. for sale in supermarkets) are handpicked with a high reliance on manual labour. Labour represents around a third of the production costs of mushrooms, and around 75% of harvesting costs. For mushroom farming and production therefore, the key factors affecting productivity and potential profitability are the availability, cost and quality of labour.

Robotic systems for automated mushroom picking already exist. Typically, these systems use vacuum suction cups to pick mushrooms. However, the force applied by the vacuum suction cups to the mushroom caps can bruise the mushroom caps, which affects mushroom quality and shelf-life.

Other systems use soft robotic end-effectors or grippers to pick the mushrooms, but while these grippers are more dextrous than a suction cup and so may need to apply less force to pick the mushrooms, they may still cause damage to the mushroom being picked or nearby mushrooms as they are bulkier than the human hand.

Since mushrooms grow in dense clusters, picking mushrooms using these existing robotic systems is difficult. It is desirable to be able to pick mushrooms without causing bruising to the mushroom being picked or to the mushrooms in the vicinity of the mushroom being picked.

The present applicant has therefore identified the need for an improved apparatus for an improved mushroom picking system which overcomes the problems mentioned above.

### SUMMARY

In a first approach of the present techniques, there is provided a computer-implemented method for picking mushrooms from a mushroom bed with a robotic mushroom picker, the method comprising: obtaining at least one image of a cluster of mushrooms in a mushroom bed; determining, within each image: each individual mushroom, a position and a height of each individual mushroom, and a radius of a cap of each individual mushroom; determining an amount of free space in the vicinity of each mushroom; determining a picking schedule based on the radius of the cap, the height and the amount of free space in the vicinity of each mushroom; and controlling the robotic mushroom picker to pick mushrooms according to the picking schedule.

Advantageously, the present techniques provide a method for picking mushrooms which takes into account their size, height, and free space in the vicinity of the mushroom when determining a picking schedule, so as to maximise yield and limit damage caused to the mushroom being picked or any mushrooms near the mushroom being picked.

The method may further comprise updating, after the picking of a mushroom, the determined picking schedule based on any changes to remaining mushrooms in the cluster of mushrooms after picking. This is advantageous because the picking of a mushroom may have caused nearby mushrooms to shift or tilt or otherwise deviate from their original position and/or orientation. Furthermore, the picking of a mushroom may enable the remaining mushrooms to be more clearly seen, and this may reveal information (such as whether any mushrooms are in contact) which impacts the order in which the remaining mushrooms should be picked.

Obtaining at least one image may comprise obtaining at least one image captured by an RGB-D camera/sensor (i.e. a red-green-blue-depth camera or sensor).

The step of determining, within each image, each individual mushroom, may comprise performing image segmentation to generate image segments, wherein each image segment contains an individual mushroom. This may be useful because it may be easier for the pose estimation to be performed (by a neural network) based on images of individual images.

The method may further comprise estimating a pose of each identified individual mushroom by: inputting each image segment into a trained neural network; and predicting, using the trained neural network, a quaternion or Euler representation of a rotation of each mushroom.

As explained in more detail below, determining a picking schedule may depend on the end effector being used to harvest the mushrooms.

Therefore, in one example, determining a picking schedule based on the radius of the cap, the height, and free space in the vicinity of the mushroom may comprise categorising each mushroom into: a first category representing mushrooms that can be picked immediately in a preferred pick direction, a second category representing mushrooms that can be picked in a preferred pick direction after at least one obstructing mushroom has been picked, or a third category representing mushrooms that cannot be picked in a preferred pick direction without interfering with another third category mushroom.

In an alternative example, determining a picking schedule based on the radius of the cap, the height and the amount of free space in the vicinity of each mushroom may comprise: filtering the mushrooms based on whether the radius of the cap is within a predefined range; filtering the mushrooms based on whether there is sufficient free space in the vicinity of each mushroom to enable it to be picked; and scheduling taller mushrooms to be picked before shorter mushrooms.

Controlling the robotic mushroom picker to pick mushrooms may comprise controlling an orientation of the robotic mushroom picker to pick each mushroom based on a corresponding preferred pick direction in the picking schedule.

In a second approach of the present techniques, there is provided a robotic mushroom picker comprising: a robotic arm and a robotic end effector coupled to the robotic arm; a vision system for: obtaining at least one image of a cluster of mushrooms in a mushroom bed; determining, within each image each individual mushroom, a height of each individual mushroom, and a radius of a cap of each individual mushroom; and determining an amount of free space in the vicinity of each mushroom; a planning system for determining a picking schedule based on the radius of the cap, the height and the amount of free space in the vicinity of each mushroom as determined by the vision system; and a control system for controlling the robotic arm and robotic end effector to pick mushrooms according to the picking schedule.

The vision system may comprise an RGB-D camera.

The vision system may be further configured to estimate a pose of each identified individual mushroom.

Controlling the robotic mushroom picker to pick mushrooms may comprise controlling an orientation of the robotic mushroom picker to pick each mushroom based on a corresponding preferred pick direction in the picking schedule.

The robotic end effector may comprise a perforated belt and a vacuum cup coupled to a vacuum source. As described below, this may be advantageous because currently available standard vacuum cups directly contact a mushroom cap (which could damage the mushroom cap), while in the present techniques, the perforated belt is sandwiched between the vacuum cup and mushroom cap during the picking process. In this case, controlling the robotic arm and robotic end effector may comprise: pressing the perforated belt of the end effector onto a cap of a mushroom; driving the perforated belt in a first direction to break a stem of the mushroom; driving the perforated belt in a second direction to return the mushroom to a centre of the robotic end effector; driving the vacuum cup onto a portion of the perforated belt that is pressed onto the cap of the mushroom; and supplying negative air pressure to the vacuum cup, thereby gripping the mushroom by the perforated belt and vacuum cup.

For this end effector, determining a picking schedule may comprise categorising each mushroom into: a first category representing mushrooms that can be picked immediately in a preferred pick direction, a second category representing mushrooms that can be picked in a preferred pick direction after at least one obstructing mushroom has been picked, or a third category representing mushrooms that cannot be picked in a preferred pick direction without interfering with another third category mushroom.

Advantageously, the end effector formed of a perforated belt and vacuum cup applies much less suction pressure to the mushroom, because the vacuum cup is not used to break the mushroom stem. Less suction pressure reduces the force applied by the vacuum cup to the mushroom, thereby reducing the chance of bruising or damage being caused. Furthermore, the application of suction by the flexible cup through the belt avoids direct contact between the vacuum cup and the mushroom cap, further reducing any risk of bruising.

Alternatively, the robotic end effector may comprise a vacuum cup only, without a belt. In this case, the vacuum cup comprises: a plurality of vacuum distribution channels on an inner surface of the vacuum cup, extending between a vacuum transfer port and an outer edge of the suction cup; and a plurality of protrusions on an inner surface of the vacuum cup for gripping a mushroom. Preferably, the vacuum cup may be releasably coupled to the robotic end effector. This may enable the different size vacuum cups to be coupled to the robotic end effector depending on the size of mushroom(s) to be harvested. The vacuum cup may be swapped during the harvesting of multiple mushrooms from a mushroom bed. Advantageously, the vacuum distribution channels of this modified vacuum cup evenly distributes the compression force generated by the vacuum over as much of the area of the vacuum cup and mushroom cap as is practical. As a result, the bruising that often occurs when typical vacuum cups are used to harvest mushrooms is reduced or eliminated.

Furthermore, this modified vacuum cup maximises the cup-to-mushroom contact area to reduce the level of vacuum required to achieve enough friction to overcome the applied torque when breaking a mushroom stem. This is achieved by the plurality of protrusions, which increase friction between the mushroom and the suction cup.

In this case, controlling the robotic arm and robotic end effector may comprise: driving the vacuum cup onto a cap of a mushroom; supplying negative air pressure to the vacuum cup, for retaining a portion of the cap of the mushroom in the vacuum cup; and rotating the vacuum cup while a portion of the cap of the mushroom is retained in the vacuum cup, to break a stem of the mushroom.

For this end effector, determining a picking schedule based on the radius of the cap, the height and the amount of free space in the vicinity of each mushroom may comprise categorising each mushroom into: a first category representing a tallest mushroom and first mushroom to be picked; a second category representing mushrooms that can be picked immediately after the first mushroom has been picked; or a third category representing mushrooms that cannot currently be picked. The categorisation may be performed after filtering the mushrooms based on whether the radius of the cap is within a predefined range. Additionally or alternatively, the categorisation may be performed after filtering the mushrooms based on whether there is sufficient free space in the vicinity of each mushroom to enable it to be picked. Thus, the picking schedule generally schedules taller mushrooms to be picked before shorter mushrooms, and in each picking round may pick the tallest mushroom first, as the tallest mushroom may be pickable without damaging surrounding mushrooms.

For this end effector, controlling the robotic arm and robotic end effector may further comprise: moving the vacuum cup to tilt the mushroom to be substantially vertical, when the picking schedule indicates that the mushroom is at an angle to the vertical direction.

The vision system may comprise a trained neural network for estimating a pose of each individual mushroom.

The planning system may update the picking schedule after a mushroom has been picked.

In a third approach of the present techniques, there is provided a robotic end effector couplable to a robotic arm picking, harvesting or lifting fragile objects, the robotic end effector comprising: a perforated drive belt provided on at least two rotating shafts, wherein a portion of the perforated drive belt contacts a fragile object during a picking operation; and a vacuum cup couplable to a vacuum source, wherein during a picking operation the vacuum cup is moveable onto the portion of the perforated drive belt and arranged to supply negative air pressure to the fragile object through the perforated drive belt.

In use, the perforated drive belt may be pressed down onto and may grip a portion of the fragile object (by frictional forces). Once gripped, the belt may be driven by the at least two rotating shafts (which are controlled by a suitable actuator or motor) in a first direction to harvest the fragile object (if required). When the belt moves in the first direction, the pulling force on the fragile object may cause, for example, a stem to break or snap. The belt may then be driven in a second, opposite direction to bring the fragile object back into the centre of the end effector so that it is substantially vertical/upright. When in this position, the flexible cup may be moved onto the belt and the negative air pressure supplied by the flexible cup enables the fragile object to be lifted away. A robotic arm coupled to the end effector can then be controlled to lift and move the fragile object to a new location.

Alternatively, the belt may be pressed down onto and may grip a portion of fragile object, and the flexible cup may then be moved onto the belt to supply negative air pressure to the fragile object through perforations of the perforated drive belt. The drive belt may then be moved in the first direction and second direction as mentioned above. In this case, the suction is applied by the flexible cup while the belt is being driven.

In a fourth approach of the present techniques, there is provided a robotic end effector couplable to a robotic arm picking, harvesting or lifting fragile objects, the robotic end effector comprising: a vacuum cup couplable to a vacuum source. The vacuum cup may comprise: a plurality of vacuum distribution channels on an inner surface of the vacuum cup, extending between a vacuum transfer port and an outer edge of the vacuum cup; and a plurality of protrusions on an inner surface of the vacuum cup for gripping the fragile object.

In use, the vacuum cup may be driven or otherwise provided onto a surface of the fragile object, and the vacuum cup may supply to retain a portion of the surface of fragile object in the vacuum cup. The vacuum cup may be moveable and/or rotatable, which may enable the end effector to manipulate the fragile object.

In the third and fourth approaches, the fragile object may be any object which needs to be gripped without excessive force to avoid damage to the object. The fragile object may be a food item or agricultural produce. For example, the fragile object may be any one of: a fruit (such as berries, apples, tomatoes, peaches, plums, and so on), a vegetable, a salad crop, a mushroom, and an egg. It will be understood that this is an example, non-limiting list of possible objects that could be harvested, picked or lifted.

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

### BRIEF DESCRIPTION OF THE DRAWINGS

Implementations of the present techniques will now be described, by way of example only, with reference to the accompanying drawings, in which:

FIG. 1 is a block diagram of a robotic mushroom picking system;

FIGS. 2A and 2B show a first example end effector for picking mushrooms;

FIGS. 3A and 3B show a second example end effector for picking mushrooms;

FIG. 4A shows a process for determining how to pick mushrooms using the robotic mushroom picking system;

FIG. 4B illustrates angles used to determine a pose or orientation of mushrooms;

FIG. 5 illustrates how a picking schedule may be implemented for the first example end effector;

FIGS. 6A to 6D illustrate how a picking schedule may be implemented for the second example end effector; and

FIG. 7 is a flowchart of example steps to pick mushrooms using a robotic mushroom picking system.

### DETAILED DESCRIPTION OF THE DRAWINGS

Broadly speaking, embodiments of the present techniques provide a method for harvesting mushrooms which grow in clusters, by determining a picking schedule that maximises the yield while minimising damage to the mushroom or surrounding mushrooms to thereby increase shelf-life.

Mushrooms typically comprise a mushroom cap, a stem or stalk that is connected to the mushroom cap, and a sack or volva at the base of the stem nearest the ground or growing bed. When picking mushrooms, it is generally desirable to pick a mushroom by breaking the stem at or near the location of the sack. In this way, the harvested mushroom comprises the cap and a length of stem. Thus, when reference is made herein to breaking the stem of a mushroom, it will be understood that the stem is broken at or near the location of the sack of the mushroom. As mentioned above, mushrooms typically grow in clusters. While human mushroom pickers may be able to manoeuvre their hands and fingers towards an individual mushroom within a cluster, grip the stem and break the stem at or near the location of the sack, it is difficult for robotic pickers to do the same because of their size and limited range of motion. Therefore, typically, robotic pickers pick mushrooms by gripping the mushroom cap which is more easily accessed by the robotic picker than the stem. It is desirable to minimise damage to the cap of the mushroom during this picking process by a robotic picker.

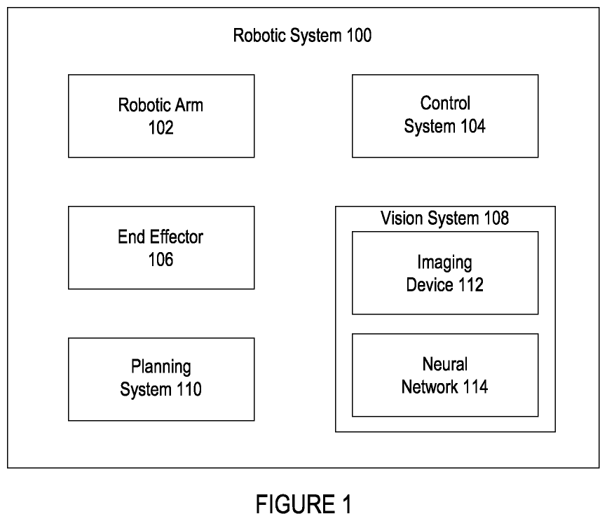

FIG. 1 shows a block diagram of a robotic mushroom picking system 100 which may be used to pick or harvest mushrooms. The robotic system comprises a robotic arm 102, and a control system 104 that controls the robotic arm 102. The robotic arm may be a 4-axis gantry robot (X, Y, Z and A (rotation about the Z axis)) that provides the mechanical means of picking a mushroom from a growing bed.

The control system 104 may comprise at least one processor coupled to memory. The at least one processor may comprise one or more of: a microprocessor, a microcontroller, and an integrated circuit. The memory may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The at least one processor and memory of the control system 104 may be used by other components of robotic system 100, such as by vision system 108 and/or planning system 110. Additionally or alternatively, the processor and memory of the control system 104 may be dedicated to controlling the robotic arm and end effector. In this case, the vision system 108 and planning system 110 may utilise one or more additional processors for performing their specific tasks.

The robotic system comprises an end effector 106, also referred to herein as a ‘gripper’. The end effector 106 is coupled to the robotic arm, and the control system 104 may be configured to control the motion of both the robotic arm 102 and the end effector 106 to pick mushrooms. The end effector 106 may take any suitable form. Two example end effectors 106A and 106B are described below.

The robotic system comprises a vision system 108 which is used to capture images of a mushroom bed and detect mushrooms for picking by the end effector 106. The vision system 108 may be used to obtain or capture at least one image of a cluster of mushrooms in a mushroom bed. The image(s) may show a whole cluster or part of a cluster of mushrooms. The vision system 108 may comprise an imaging device 112. The imaging device may be an RGB-D (red-green-blue-depth) camera for capturing colour images that comprise depth information of the cluster of mushrooms. The vision system 108 may capture images of mushrooms in a mushroom bed from above the bed. The dimensions of that image may be based on a number of factors, such as the height of the imaging device 112 from a surface of the bed and the field of view of the imaging device. The images may overlap. The overlap area between the images may be based on the biggest diameter of a mushroom.

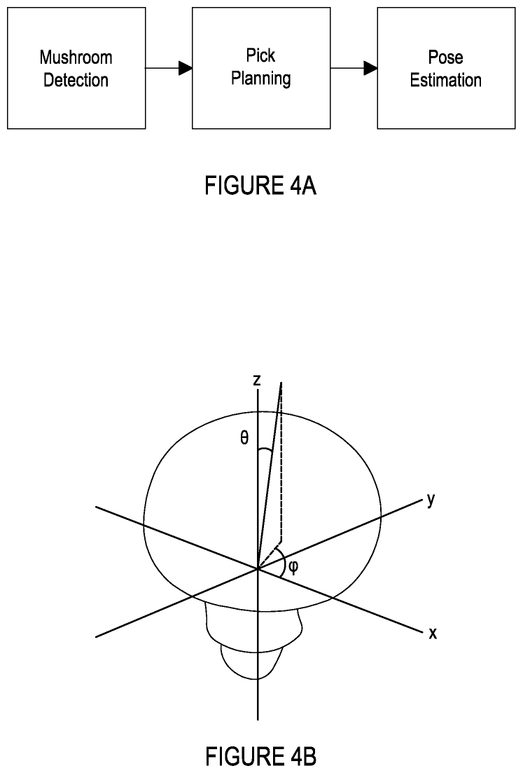

The vision system 108 may analyse the RGB-D images to identify each individual mushroom with the cluster, and may determine a position of each mushroom in three-dimensional space (where x, y, z coordinates may define the position, and the coordinates may be defined relative to a position of the robotic system or relative to the mushroom bed, or otherwise). The vision system 108 may determine a height of each individual mushroom. The height may be determined using the determined height or depth value. For example, the position of each mushroom along the z axis (see FIG. 4B) may be used to determine the height of each mushroom. The vision system 108 may determine a radius of a cap of each individual mushroom. This information determined by the vision system 108 may enable a mushroom picking schedule to be determined.

The vision system 108 may also determine an amount of free space in the vicinity of each mushroom. This may comprise determining an absolute amount of free space around each mushroom. Alternatively, this may comprise determining whether there is sufficient free space around each mushroom to enable the mushroom to be picked using a particular end effector 106 (and associated picking technique). As described below in more detail, an end effector may push or pull a mushroom in the x-y plane in order to break the stem of the mushroom, or an end effector may tilt and twist a mushroom cap in order to break the stem of the mushroom. Each of these techniques requires a certain amount of space in the vicinity of the mushroom, to accommodate the end effector and to enable the end effector to move the mushroom (e.g. push-pull or tilt-twist) in order to break the stem of the mushroom. Thus, the robotic system 100 may determine whether there is sufficient free space in the vicinity of each mushroom to enable a particular end effector to be used to pick the mushroom. As explained below, this may be performed by a planning system 110 of the robotic system 100. The space requirements of the (or each) end effector used by system 100 may be stored within the system 100 or planning system 110, so that the planning system 110 can make this determination.

The vision system 108 may comprise a trained neural network 114 to estimate the pose or orientation of each individual mushroom.

As mentioned above, vision system 108 may comprise at least one processor (coupled to memory) for implementing the above-mentioned functions. Alternatively, the vision system 108 may utilise the processor(s) of the control system 104 or other processors of the robotic system 100.

The robotic system 100 comprises a planning system 110 which determines a picking schedule, i.e. an order in which to pick mushrooms from the mushroom bed. The planning system 110 determines the picking schedule based on some analysis performed by the vision system. The determined picking schedule is then provided to the control system 104 so that the control system can control the robotic arm 102 and end effector 106 to pick mushrooms in the order defined by the picking schedule. In other words, the planning system 110 integrates information determined by the vision system 108, including mushroom locations, mushroom sizes and the amount of free space surrounding each mushroom, to generate an optimal order in which to pick the mushrooms to reduce damage to surrounding mushrooms. The planning system 110 may also use information on how close each mushroom is to another mushroom to determine the picking schedule. The planning system 110 may determine an updated picking schedule whenever a mushroom is picked since the picking of a mushroom may cause movement of nearby mushrooms and as such, may impact which mushroom should be picked next.

Once harvested, the mushrooms may be lifted by the end effector 106 and robotic arm and deposited in a different location. For example, the mushrooms may be deposited into containers or onto food processing conveyor belts. The mushrooms may be sorted by size and/or grade into different containers. The size and/or grade of each mushroom may be determined by the vision system 108 based on some pre-defined criteria (e.g. size categories).

The robotic system 100 of the present techniques tackle the problem of picking mushrooms as well as maximising the yield and reducing damage to the picked and unpicked mushrooms. The robotic system 100 is capable of extracting mushrooms from clusters and minimising damage to surrounding mushrooms. Advantageously, the robotic system 100 uses location, free space and neighbouring mushrooms, and mushroom size information to determine the picking schedule, and takes into account the specific geometry of the end effector 106 which may impact which mushrooms can be accessed for picking. As a result, the robotic system 100 reduces damage to the mushrooms as they are picked, as well as reducing potential damage to surrounding mushrooms, by accounting for mushroom pose and location as it relates to the mushroom being picked and the size and shape of the gripper.

After the mushroom picking schedule has been determined, the trained neural network 114 may be used to estimate the pose or orientation of the first mushroom to be picked according to the picking schedule. The pose or orientation information is used to determine how the robotic arm 102 should approach the first mushroom in order to pick the mushroom. That is, the pose/orientation of each mushroom may impact the angle and orientation of the end effector as it approaches the mushroom. It is desirable to take the mushroom pose/orientation into account when controlling the end effector because the angle at which, or direction in which, the end effector approaches and contacts the mushroom cap of a mushroom may improve or maximise contact space between the end effector 106 and mushroom cap, which may thereby eliminate or reduce slippage of the end effector on the mushroom cap and any bruising the slippage may cause. Thus, as explained in more detail below, the pose/orientation of each mushroom may be used to define a preferred pick direction for each mushroom.

The trained neural network 114 may be used to estimate the pose of the first mushroom to be picked on the picking schedule. When the picking schedule is updated after a mushroom has been picked, a new first mushroom to be picked is shown on the updated picking schedule, and the trained neural network 114 may estimate the pose of this new first mushroom. Thus, the trained neural network 114 may be used to estimate the pose of only the first mushroom on each picking schedule. Using the trained neural network 114 to estimate the pose of only the first mushroom on the picking schedule may be advantageous because, as noted above, the mushrooms in the vicinity of a harvest mushroom may move. Thus, it may not be efficient to estimate the pose of every mushroom on the picking schedule since the pose of the mushrooms may change during the harvesting process.

The gripper/end effector, the vision system, and the planning system are now described in turn.

### End Effector/Gripper

A key element of the robotic mushroom harvesting system is the end effector or gripper 106, which needs to harvest highly delicate mushrooms without causing bruising or reducing their shelf life. At the same time, the gripper needs to be capable of generating enough force to break a mushroom stalk during picking. Those two conflicting operational requirements impose challenging design requirements for the gripper.

As explained above, the end effector or gripper 106 breaks a mushroom stem/stalk at or near the location of the sack/volva and lifts mushrooms without bruising the mushroom, which should improve the performance of the system 100 in terms of mushroom quality and shelf-life. Two example end effectors are described below, which may be used in robotic system 100 to pick mushrooms.

### End Effector Example—Belt and Vacuum

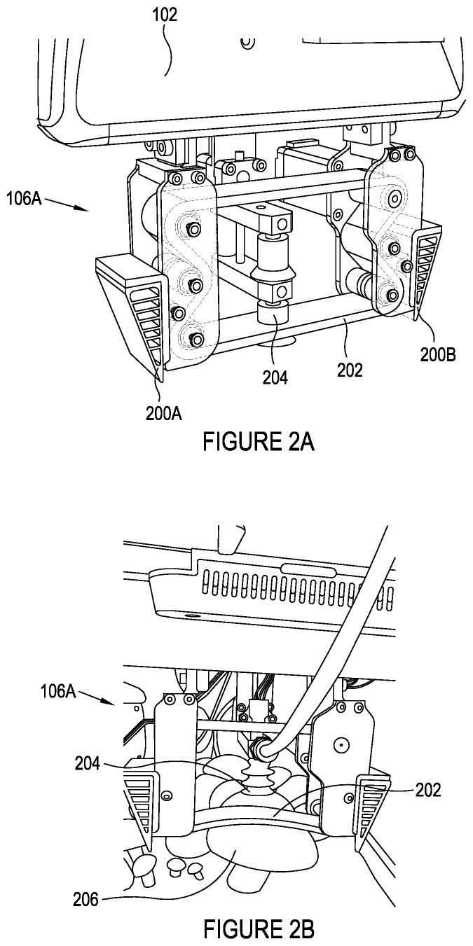

FIG. 2A shows a first example end effector 106A, and FIG. 2B shows the first example end effector 106A being used to pick a mushroom 206. End effector 106A comprises a soft flat perforated belt 202, and a flexible cup 204 that is coupled to a vacuum source (not shown). In use, the belt 202 may be pressed down on to a cap of a mushroom to be picked from above. Once a mushroom is gripped in this way by the belt, the belt 202 may be driven in a first direction such that the mushroom stem is broken. Once the stem has been broken, the belt 202 may be driven in a second direction to return the mushroom to a centre of the robotic end effector, such that it is centred within the end effector and/or such that it is substantially vertical. The flexible cup 204 may then be driven by an actuator (not shown) towards the belt 202 such that the flexible cup 204 seals a subset of holes or perforations in the belt 202. The vacuum source coupled to the flexible cup 204 is able to supply negative air pressure to the cap of the mushroom through the subset of holes in the belt 202. This negative air pressure provides enough upward force to enable the cap of the mushroom to be gripped by the belt 202 and cup 204.

Specifically, the belt 202 may be pressed down onto and may grip the cap of a mushroom. Once gripped, the belt 202 may be driven in a first direction to break or snap a stem of the mushroom. When the belt 202 moves in the first direction, the pulling force on the mushroom may cause the stem to break or snap. The belt 202 may then be driven in a second, opposite direction to bring the mushroom back into the centre of the end effector 106A so that it is substantially vertical/upright. When in this position, flexible cup 204 may be moved onto the belt 202 and the negative air pressure supplied by the flexible cup 204 enables the mushroom to be lifted off the mushroom bed. The robotic arm 102 can then be controlled to lift and deposit the mushroom in a container.

The end effector 106A may be brought into contact with the mushroom in a direction that enables the stem to be broken in a particular direction. For example, as mentioned above, it may be desirable to break the stem in a preferred pick direction. The preferred pick direction may be in an opposite direction to the pose or direction of growth of the mushroom, as this may help to break the stem. Additionally or alternatively, the preferred pick direction may be in a direction that prevents damage to nearby mushrooms during the picking process, which may be a direction that comprises sufficient empty space around the mushroom to be picked. Thus, the preferred pick direction may be determined using the information on the amount of (and location of) free space surrounding each mushroom to be picked. The combination of the belt, cup and angle of the belt relative to the pose of the mushroom enable the mushroom stem to be broken without bruising of, or with limited bruising to, the mushroom. The mushroom may remain gripped by the belt 202 after the stem has been broken, and may be lifted and gripped using the flexible cup 204 The robotic arm 102 and end effector 106A may be controlled to deposit the mushroom into a container or onto a food processing conveyor belt, as noted above.

A key difference between this belt and vacuum approach and other existing vacuum-based systems, is that the belt 202 is the component used to break the mushroom stalk, not the vacuum cup 204. As a result, the end effector 106A applies much less suction pressure to the mushroom, which ensures that no bruising is caused. This advantage is also achieved by the application of suction by the flexible cup 204 (after the mushroom stem has been broken) through the soft belt 202 which thereby avoids direct contact between the cup and the mushroom cap, further reducing any risk of bruising.

The method for picking a mushroom based on the end effector shown in FIGS. 2A and 2B may be as follows:
1. Identify mushroom coordinates using the vision system.
2. Adjust the belt opening distance based on target mushroom. A linear actuator (not shown) is used to move two opposing plates upon which the belt mechanism is carried. When the plates are moved further apart, the belt 202 is stretched, and vice versa. Thus, the belt 202 may be stretched at this stage.
3. Lower belt onto the mushroom cup to passively adapt to the mushroom cap profile. In other words, as the belt 202 is pressed onto a mushroom cap, it naturally stretches and changes shape to match the profile or contour of the mushroom cap. This is advantageous as the belt 202 can work with mushroom caps of any profile or contour, and no additional mechanism is needed to ensure the belt 202 is in contact with the mushroom cap.
4. Rotate the belt in a first direction using a DC motor (not shown) to apply a torque required to break the mushroom stalk. The DC motor may be different to the linear actuator, such that different mechanisms are used to control the belt opening distance and the belt rotation.
5. Rotate the belt in a second direction (where the second direction is in the opposite direction to the first direction), to return mushroom to centre of gripper.
6. Release belt tension by closing the opening distance further.
7. Lower soft vacuum cup against the belt.
8. Apply suction through perforated part of the belt using pneumatic control board.
9. Lift the loose mushroom up using the robot arm.
10. Stop suction when ready to release mushroom into a container or onto a conveyor belt.

The soft belt 202 may be made from highly stretchable silicone rubber that can stretch several times its original length without breaking. It will be understood that this is merely an example, non-limiting material and that other suitable materials with similar elastic properties may be used to form the belt 202. This allows the soft belt to passively and gently adapt to variable mushroom sizes, which maximises the contact area necessary for the generation of sufficient torque to break the stalk. Food-safe silicone rubbers are commercially available and are easy to tint with a desired colour (e.g. blue) to satisfy food hygiene requirements in case of belt breakage. Furthermore, these materials may be cleanable using food-safe/food-grade chemicals.

The belt 202 may be fabricated using a moulding process. For example, the belt may be formed using 3D-printed moulds. It will be understood that this is merely an example, non-limiting manufacturing process. An advantage of the belt is that simple fabrication and inexpensive materials may be used to make the belts and hence, the belts can be easily replaced as needed.

An advantage of the soft belt and cup end effector is that the soft belt can gently stretch to adapt to different mushroom sizes. Furthermore, as the belt is stretched it also stiffens, which would be useful when dealing with larger, heavier mushrooms. Advantageously, the gripper/end effector does not depend on accurate estimation of tilt angle from the vision system. Moreover, inexpensive and simple fabrication makes the belt easily replaceable.

The perforations in the soft belt 202 may be shaped to provide the maximal lifting force generated by the vacuum source while at the same time minimising the reduction in linear belt strength that a vertical array of holes through a soft material inevitably produces.

The end effector 106A comprises a first finger 200a and a second finger 200b. The first and second fingers may be used to prevent any other mushrooms from coming into contact with the belt 202, particularly when the belt is in motion.

Experiments performed using the end effector 106A showed that achieving the required torque output did not come at the expense of mushroom bruising. An initial bruising evaluation showed almost no instant or longer-term bruising (evaluated after seven days of the picking), even when utilising the maximum torque output of the end effector 106A. These tests confirmed that the end effector 106A can achieve the difficult balance between torque generation and minimal mushroom bruising requirements.

The belt on its own is not capable of lifting a mushroom upwards. To achieve this, as mentioned above, the belt 202 is combined with a vacuum cup 204, where the belt breaks a mushroom stalk and the vacuum cup 204 applies negative air pressure (suction) to the mushroom to lift the mushroom. Vacuum cups 204 tend to bruise the cap of the mushroom where they contact the mushroom, because typically, standard vacuum cups are also used to break the mushroom stalk and so the force applied by the vacuum cup is high. However, in the end effector 106A, the vacuum is not used to break the mushroom but to lift a mostly loose mushroom, which requires far less suction to be applied. Furthermore, since the negative air pressure is applied through the belt (as explained above), there is no direct contact between the vacuum cup 204 and the mushroom cap, which reduces the risk of bruising during the harvesting process. Further still, as less suction is required, the overall size of the end effector 106A may be more compact than end effectors that use suction to break and lift a mushroom.

Although the first end effector 106A has been described in the context of harvesting mushrooms, the first end effector 106A may be suitable for picking, harvesting and/or lifting objects other than mushrooms. For example, the first end effector 106A may be used in robotic systems suitable for harvesting, picking and/or lifting and moving other easily-damaged objects, such as soft fruits, vegetable and salad crops, and even eggs. Thus, the present techniques also provide a robotic end effector couplable to a robotic arm for picking fragile objects, the robotic end effector comprising: a perforated drive belt provided on at least two rotating shafts, wherein a portion of the perforated drive belt contacts a fragile object during a picking operation; and a vacuum cup couplable to a vacuum source, wherein during a picking operation the vacuum cup is moveable onto the portion of the perforated drive belt and arranged to supply negative air pressure to the fragile object through the perforated drive belt.

### End Effector—Improved Vacuum Cup

Conventional, off-the-shelf suction cups are designed to pick up objects made from a smooth, hard, and non-porous material. Since the objects are hard, these suction cups have not been designed to minimise contact pressure. Such suction cups simply have to be able to generate enough compressive force between themselves and a target object to be able to pick up the object and move the object to a new location.

However, this is not the case when picking very soft objects such as ripe fruit or fresh mushrooms, as areas of high contact pressure between the soft object and suction cup can cause bruising or other damage. Suction cups designed to pick soft, fragile objects must therefore be designed in a way to provide the maximum overall compressive force while minimising contact pressure (=force/area.)

Conventional suction cups use a wide skirt to provide a vacuum seal and a relatively large central hole to allow air flow between the vacuum source and the cup vacuum sealing skirt. Consequently, this generates high contact pressure around the circular edge where the cup transitions from skirt to central vacuum transfer port. Additionally, their relatively wide skirts provide very little compressive force between cup and object once the vacuum seal is made-almost all the lifting force is generated by their large central vacuum transfer port hole which acts across only a fraction of the total cup surface area.

These problems are compounded when friction is also required to grip the target object and apply a torque to it, such as when using a suction cup to break the stem of a mushroom in its growing bed by rotating it about an axis (typically a longitudinal or vertical axis of the stem). The relatively wide skirt is less optimal at generating the required friction, while the large diameter transfer port provides no friction to oppose the applied torque at all.

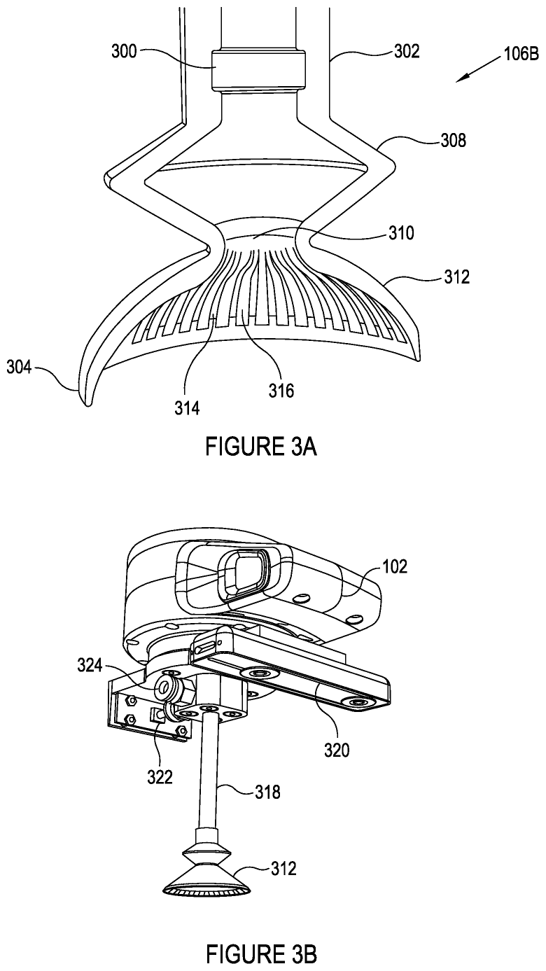

FIG. 3A shows a second example end effector 106B, and FIG. 3B shows the second example end effector 106B coupled to an arm of the robotic system. The second example end effector 106B comprises a vacuum cup 312 that has been designed to overcome the above-described limitations of conventional suction cups, to enable the harvesting of mushrooms without causing bruising. End effector 106B is used to harvest mushrooms by gripping a mushroom cap, tilting the mushroom cap, and then twisting the mushroom cap. This tilting and twisting action causes the stem of the mushroom to break at or near to the location of the sack. The action is similar to the action a human picker uses to harvest mushrooms (except a human picker would grip the stem of the mushroom not the cap).

The second example end effector uses the mushroom orientation/pose that is estimated by the trained neural network 114 to drive the vacuum cup 312. That is, if the mushroom cap is determined to be at an angle to the vertical direction, the vacuum cup 312 may grip the mushroom cap and then apply a force to tilt the mushroom so that the mushroom cap is substantially vertical. This also ensures that the vacuum cup 312 is in better contact with a surface of the mushroom cap, as the vacuum cup and mushroom cup are better aligned. This may enable less suction to be applied, which may thereby reduce the risk of bruising.

The second example end effector 106B comprises a vacuum or gripper cup 312. The vacuum cup 312 comprises a vacuum sealing skirt 304 provided around a circumference of the vacuum cup 312. The vacuum cup 312 comprises a plurality of vacuum distribution ports 314 provided on an inner surface of the vacuum cup. The vacuum cup 312 comprises a plurality of protrusions 316 that form grippers on the inner surface of the vacuum cup. The plurality of vacuum distribution ports 314 and plurality of protrusions 316 may be formed by providing a ribbed pattern (i.e. alternating recesses and protrusions) on the inner surface of the vacuum cup. The end effector 106B comprises a vacuum transfer port 310, bellows 308, an attachment tube 302 to connect the vacuum cup to the vacuum source, and a locator ring rebate 300.

The second example end effector 106B provides maximum contact friction between the vacuum cup 312 and a mushroom by evenly distributing the compression force generated by the vacuum over as much of the area of the vacuum cup 312 and mushroom cap as is practical. This is achieved using the distribution ports 314, which are recessed horizontal vacuum channels that extend along the inner surface of the vacuum cup from the central vacuum transfer port 310 towards an outer edge of the suction cup 312, as shown in FIG. 3A.

The end effector 106B eliminates areas of high contact pressure by careful design of all transitions between cup-to-mushroom contact areas, and areas of no contact (where the vacuum is applied to the mushroom.)

The end effector 106B maximises the cup-to-mushroom contact area to reduce the level of vacuum required to achieve enough friction to overcome the applied torque when breaking a mushroom stem. This is achieved by providing the plurality of protrusions 316 which increase friction between the mushroom and the suction cup.

The end effector 106B maximises the contact friction close to the outer edge of the vacuum cup 312 where it will have the greatest effect in opposing the twisting torque. This is achieved by providing a narrow, highly flexible sealing skirt 304 around the rim or circumference of the vacuum cup 312 which allows the vacuum transfer ports to extend almost to the outer edge of the cup. The vacuum sealing skirt 304 may be angled inwards slightly to maximise the probability of achieving a vacuum seal.

The vacuum cup 312 may be formed of a material that is soft, flexible and has a high coefficient of friction. The softness and flexibility may enable the vacuum cup to contact the mushroom without damaging the mushroom. The vacuum cup 312 may be shaped to provide enough stiffness to overcome the axial and radial torque applied to it.

FIG. 3B shows how the vacuum cup 312 may be coupled to the robotic arm 102 and other components of the robotic system 100. The vacuum cup 312 may be coupled to the robotic arm 102 via a vacuum pipe 318. The vacuum cup 312 may be releasably coupled to the vacuum pipe 318. This may be advantageous as different size vacuum cups 312 may be used to pick different size mushrooms, and therefore, the vacuum cup 312 may be swapped during a harvesting process. The robotic system 100 may comprise an imaging device 320 as part of the vision system 108. The robotic system 100 may comprise a vacuum sensor 322 and a vacuum pipe inlet 324.

An advantage of the end effector 106B compared to the end effector 106A is that the end effector 106B has a more compact design that enables it to pick mushrooms from dense clusters. Furthermore, the ability to use different size vacuum cups enables the end effector 106B to pick mushrooms of any size and in any flush or to thin a mushroom bed to increase yield.

The vacuum cup 312 of the second end effector 106B may be formed of a food-safe material, which may be readily available and easy to tint with a desired colour (e.g. blue) to satisfy food hygiene requirements in case of breakage. Furthermore, these materials may be cleanable using food-safe/food-grade chemicals.

The method for picking a mushroom based on the end effector shown in FIGS. 3A and 3B may be as follows:
1. Drive the vacuum cup onto a cap of a mushroom;
2. Supply negative air pressure to the vacuum cup, for retaining a portion of the cap of the mushroom in the vacuum cup;
3. Move or tilt the vacuum cup to tilt the mushroom so that it is substantially vertical, when the picking schedule indicates that the mushroom is at an angle to the vertical direction. Thus, this step may only be performed in certain circumstances. Alternatively, tilting may generally always be performed as mushrooms often grow at an angle to the vertical direction.
4. Rotating the vacuum cup while a portion of the cap of the mushroom is retained in the vacuum cup, to thereby break a stem of the mushroom by a twisting action.

### Vision System

It is difficult to see individual mushrooms which grow in clusters, even if multiple cameras at different positions are used. This not only means that it is difficult to determine individual mushrooms for picking, but also that it is difficult to see or estimate the pose or orientation of the mushroom. Knowing the pose of the mushroom is important because it helps to determine how to pick the mushroom. As a result of the difficulty of identifying individual mushrooms in a cluster, typical pose estimation systems do not accurately predict pose of the mushrooms. The vision system 108 of the robotic system provides improved techniques for identifying mushrooms and predicting mushroom pose.

The vision system 108 comprises computer vision techniques to find the location and radius of mushrooms in a given input image, in addition to determining an amount and location of free space in the vicinity of each mushroom. The vision system 108 comprises a neural network architecture 114 which estimates the quaternion representation and/or Euler angles representing rotations of a mushroom using RGB and depth data. As explained above, the trained neural network 114 may be used to estimate a pose or orientation of each mushroom. The major benefit of having location, radius, free space information and pose data for each mushroom is that it allows the orientation of the gripper to be adjusted for each specific mushroom, it follows from that mushroom harvest yields should be increased and damage to harvested mushrooms decreased.

FIG. 4A shows a flow chart of example steps of a method to determine a picking schedule based on images of a mushroom bed. The method may comprise obtaining at least one image of a cluster of mushrooms in a mushroom bed. The vision system may therefore comprise at least one imaging device 112. The imaging device may be an RGB-D (red green blue-depth) camera. The imaging device may be mounted on a robotic arm 102 of the robotic system 100. See for example imaging device 320 in FIG. 3B. Additional lighting devices may be provided around or in the vicinity of the imaging device to enhance the image capture process.

The computer vision system 108 may process an image of a mushroom bed captured by the imaging device mounted on the robotic arm 102. The position of the robotic arm 102 when this image is captured may be pre-set to enable either the capture of an image of a portion of the mushroom bed or the capture of an image of the whole of the mushroom bed, depending on the task to be performed using the image. In a particular example, what each image shows depends on a height of the imaging device and the field of view that imaging device, and therefore, the imaging device may only be able to capture images of portions of the mushroom bed.

The vision system 108 may comprise a Realsense D415 camera to capture RGB and depth images. It will be understood that is a non-limiting example camera that may be used, and other suitable cameras or imaging devices may be used instead. The camera may be calibrated for operation at around 300 mm from the mushroom bed.

The RGB-D camera may be used to capture an RGB image and a depth image from the same viewpoint (i.e. the same pre-set position).

For each RGB image, the method may comprise identifying each individual mushroom within the image (i.e. “mushroom detection” in FIG. 4A). The method may also comprise identifying or determining a height of each individual mushroom, and a radius of a cap of each individual mushroom. Identifying each individual mushroom from an RGB image may comprise pre-processing the RGB image. The pre-processing may comprise sharpening the edges of objects within the RGB image, darkening the image background and lightening the foreground, and performing morphological operations to facilitate mushroom detection. More specifically, the pre-processing may comprise converting the RGB image to greyscale. Converting the RGB image to greyscale may comprise applying a function which defines a threshold below which RGB pixels are set to zero.

Once the RGB image has been pre-processed, circular objects believed to be mushrooms may be identified within the image. A function applied to the RGB image may return a list of circles found in the image (if any). A circle is defined by its centre coordinates in the image and radius. Thus, the list outputted by the function may be a list of tuples [(x, y, z, r) . . . ] where x, y and z are the coordinates of the centre of each circle, and r is the radius of that circle. A tuned Hough transformation may be used to identify mushrooms based on radius. The Hough transformation uses four parameters: a first parameter that governs the sharpness of an edge accumulator, a second parameter for the number of circles identified, a third parameter defining a minimum radius, and a fourth parameter defining a maximum radius. The minimum and maximum radius parameters are used for implementing yield control, as they enable the harvesting of mushrooms of a specified size only. Thus, any mushrooms that are too small (i.e. have a cap radius that is below the minimum radius parameter), will not be picked. By not picking these mushrooms, they are able to grow larger and can be picked during a subsequent harvest. The minimum radius parameter may be pre-defined and variable, depending on the size of mushrooms to be harvested during a particular harvesting session. For example, mushrooms may be harvested to thin out a mushroom bed-in this case, the mushrooms may be quite small. Similarly, mushrooms may be harvested for sale-in this case, the mushrooms may be larger.

Post-processing techniques may be used to remove overlaps and false positives. This may comprise bespoke error handling mechanisms to remove false positives, and bespoke mushroom circle overlap removal. These post-processing techniques may be used to, for example, check whether a large circle contains a single large mushroom or a cluster of smaller mushrooms. As it is undesirable to pick mushrooms below a certain minimum radius, these post-processing techniques are useful for removing false positives.

The post-processing techniques may comprise filtering the list of circles to remove any circles which contain other circles. This is done to remove false detections of large mushrooms caused by the Hough circle algorithm connecting arc segments from multiple mushrooms which are in close proximity. The filtering process may comprise checking each detected circle against all other detected circles, and calculating their intersection area (if any). If the intersection area of two circles is greater than a threshold area (e.g. 40%) of either circle, then the larger of the two circles is removed. The threshold at which to reject a circle can be altered by changing the value of the threshold area.

The vision system 108 may also determine an amount of free space in the vicinity of each mushroom. This may comprise determining an absolute amount of free space around each mushroom. Alternatively, this may comprise determining whether there is sufficient free space around each mushroom to enable the mushroom to be picked using a particular end effector 106 (and associated picking technique). As described above, an end effector may push or pull a mushroom in the x-y plane in order to break the stem of the mushroom, or an end effector may tilt and twist a mushroom cap in order to break the stem of the mushroom. Each of these techniques requires a certain amount of space in the vicinity of the mushroom, to accommodate the end effector and to enable the end effector to move the mushroom (e.g. push-pull or tilt-twist) in order to break the stem of the mushroom. Thus, the vision system 108 may determine whether there is sufficient free space in the vicinity of each mushroom to enable a particular end effector to be used to pick the mushroom.

At this stage, the method may comprise determining a picking schedule based on the radius of the cap, the height and the amount of free space in the vicinity of each mushroom (“pick planning” in FIG. 4A). Thus, the position of each mushroom to be harvested and the determined free space in the vicinity of each mushroom may be sent to the planning system 110 to determine the picking schedule. Further details of the planning system 110 are provided below.

As noted above, once a picking schedule has been determined, the trained neural network 114 may be used to estimate a pose/orientation of the first mushroom to be picked in the picking schedule (“pose estimation” in FIG. 4A). Thus, the vision system 108 may then obtain a cropped image of an individual mushroom. That is, image segmentation may be performed. The cropped image may be obtained by combining a portion of the RGB image and a portion of the depth image, where each portion contains the individual mushroom. This cropped image may be used as an input to a neural network of the vision system 108.

Each mushroom may be segmented from both the RGB and depth image by taking a square crop of the image centred on the detected mushroom centre with a width and height of the detected radius plus a small buffer region defined by the window size parameter (which may be set to 20 pixels). Thus, the segment will have size 2 (r+window size). The buffer region is used to try and ensure that the entire mushroom cap is in view in the segmented image. As the neural network relies on having a fixed sized image patch as an input when performing pose estimation, each segment is then resized to be 64×64 pixels. This size was chosen as it allows for rapid inference and low training times. A larger segment size may offer benefits in pose estimation accuracy, but would require retraining the neural network to account for the change in scale of image features.

To ensure segmentation is done as swiftly as possible, the RGB and depth image are concatenated before segmentation starts creating a H×W×4 sized image, where H and W are the height and width of the image (the default is 720 by 1280).

The neural network of the vision system 108 may be used to process the cropped RGB-D image to predict the mushroom pose or orientation (i.e. “pose estimation” in FIG. 4A). The neural network is trained on labelled images of mushrooms collected by the present Applicant. That is, each image of a mushroom used for training the neural network is labelled with manually-determined pose or orientation information. This enables the trained neural network to predict the mushroom orientation of an input image. Details of the neural network training. are provided below.

The mushroom orientation prediction is used to drive the end effector to be perpendicular with a plane of the mushroom cap.

Mushroom pose can be defined by two angles, θ and φ, as shown in FIG. 4B. The theta (θ) angle leans away from the (vertical) z axis while the phi (φ) angle goes around the z axis. A psi (ψ) angle twists around z axis which is not necessary to define the pose of the mushroom as mushrooms are approximately symmetrical (circular) around their z axis. In Euler representation, the mushroom pose is therefore (θ, φ, ψ). The Euler representation may be converted to a quaternion representation for the pose prediction and control of the robot. The planning system 110 makes use of the Euler representation.

Pose estimation is performed by providing each segmented mushroom image as an input to a convolutional neural network (CNN) which predicts the quaternion or Euler representation of the mushrooms rotation about its base. The neural network uses RGB-D data to infer the mushroom pose.

### Planning System

As shown in FIG. 4A, after mushroom detection and free space determination has been performed, it is possible to determine a picking schedule. Determining a picking schedule may be based on the radius of the cap, the height and the amount of free space in the vicinity of each mushroom. Once the picking schedule has been determined, the robotic arm 102 and end effector 106 may be controlled to pick mushrooms according to the picking schedule and the estimated pose of each mushroom.

The planning system 110 uses the aforementioned data from the vision system 108 to categorise each detected mushroom into various groups based on whether they can be picked immediately or not, and whether adjustments to a preferred picking direction needs to be made. This categorisation enables a single mushroom to be selected for picking and includes the direction in which to pick the selected mushroom. The planning system may generate a full picking schedule showing the order in which each suitable mushroom should be picked, and the direction in which each mushroom should be tilted for picking.

The picking schedule may be updated after each mushroom is picked to account for any movement of surrounding mushrooms caused by contact with the end effector 106, or changes in the pose estimation caused by changes in lighting, viewing angle or other factors. This means that if a mushroom is moved during the picking of another mushroom, the system can account for this and adjust the picking schedule (i.e. the picking order and/or the preferred picking/tilting direction) if necessary.

The planning system 110 preferably determines a picking schedule based on the end effector 106 to be used for harvesting the mushrooms, because the geometry and the interaction mechanism of the end effectors may vary (as described above with respect to end effectors 106A and 106B). Therefore, the methods to determine a picking schedule based on each of the end effectors mentioned earlier are now described.

### Planning System for End Effector 106A (Belt and Vacuum)

Once the location and radius have been determined for each mushroom in view of the camera of the vision system 108, as well as the amount of free space in the vicinity of each mushroom, the planning system 110 may categorise each mushroom into one of three categories.

Category 1—this first category represents mushrooms that can be picked immediately in a preferred pick direction. Mushrooms in category 1 have enough free space aligned with their preferred pick direction (180 degrees to the phi rotation of the mushroom) such that category 1 mushrooms can be picked without the end effector touching any other mushroom. Category 1 mushrooms will generally be the first mushrooms the planning system 110 suggests to be picked, and so will appear first in the picking schedule.

Category 2—this second category represents mushrooms that can be picked in a preferred pick direction after at least one obstructing mushroom has been picked. The obstructing mushroom(s) may be a category 1 or category 2 mushroom. Mushrooms in category 2 require that one or more mushrooms (which are category 1 or 2), be picked before they can be picked in their preferred pick direction.

Category 3—this third category represents mushrooms that cannot be picked in a preferred pick direction without interfering with another third category mushroom. Mushrooms in category 3 cannot be picked in their preferred pick direction as one or more mushrooms which are also category 3 are blocking them from being picked.

If only category 3 mushrooms are left to be picked, then further calculations may be made to determine the order in which to pick the category 3 mushrooms. The first stage of these further calculations may comprise determining if a mushroom can be picked by making a small adjustment to its pick direction. For mushrooms with a small tilt (i.e. those which are approximately upright, θ<20°), any adjustment of the pick direction (ϕ) that creates enough free space to safely pick the mushroom is considered, where the adjustment may be up to 359°. For mushrooms with a large tilt (θ≥20°) then a change of the pick direction of 90° may be allowed. Preferably, the planning system 110 is configured to provide the minimum adjustment to the pick direction, optionally with a preference for a clockwise adjustment to the rotation. These mushrooms are then further categorised as category 4 (or fourth category) mushrooms.

If the pick direction of all remaining mushrooms cannot be adjusted to allow for a successful pick, the planning system 110 calculates which mushroom should be picked in order to maximise the number of remaining mushrooms which will become category 1 and/or category 2 mushrooms after a mushroom is picked. Once the mushroom which will free up the maximum number of other mushrooms is found, a final check is made to determine if there is a pick direction which minimises the contact between the end effector 106 and any remaining mushrooms which are not currently being picked. If this is the case, the mushroom is categorised as category 5 and the adjustment to the pick direction is made. If not, then the mushroom is categorised as category 6 and the pick direction remains the preferred pick direction of the mushroom.

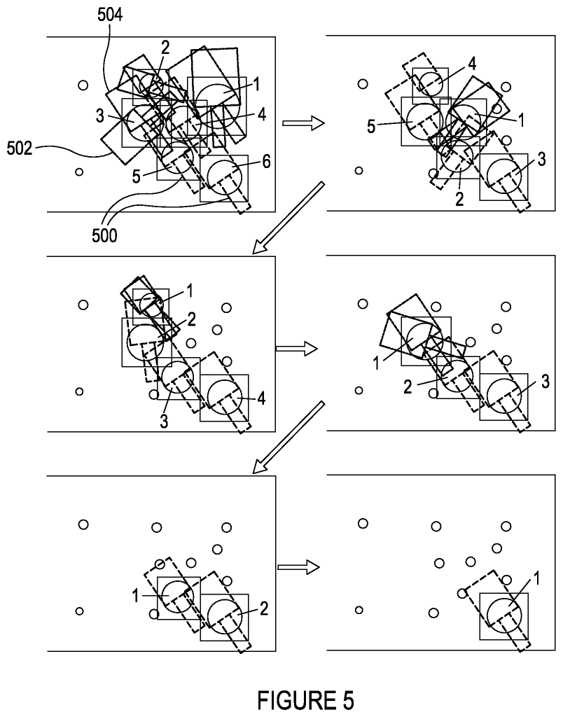

For end effector 106A described with reference to FIGS. 2A and 2B, the method to determine a picking schedule may be as described above. That is, mushrooms may be categorised as described above to determine a picking schedule. FIG. 5 shows how the picking schedule may be determined for a small cluster of mushrooms, and how it may be adjusted after each mushroom is picked. It can be seen from overlays or bounding boxes 500 that certain mushrooms on the edge of the cluster are easier to pick in the preferred pick direction. Overlay/bounding box 502 indicates a mushroom that cannot be picked in the preferred pick direction without damaging a nearby mushroom, and overlay/bounding box 504 indicates how overlay 502 could be adjusted to enable the mushroom to be picked without damaging nearby mushrooms.

### Planning System for End Effector 106B (Improved Vacuum Cup)

For the end effector 106B described with reference to FIGS. 3A and 3B, the method to determine a picking schedule may comprise categorising the mushrooms. The vacuum cup based end effector 106B may need a small amount of clearance (about 3.5 mm) in the θ direction to allow a mushroom to be tilted away a few degrees from its growing angle. This tilting action applies tension to the base of mushroom stem, and replicates how human pickers pick mushrooms. This is advantageous because replicating the tilting action reduces the chance of breaking or tearing the stem in an unacceptable way.

For this end effector, the planning system 110 may categorise each mushroom based on the following set of requirements:
Mushroom Radius—Filtering by radius is one of the preliminary steps to determine the picking schedule. It may be preferred to harvest mushrooms having a radius or diameter within a particular range (depending on, for example, whether mushrooms are being harvested for sale, or thinning, or otherwise).
Free adjacent space—Free space refers to the space around a mushroom that does not contain any obstacles such as other mushrooms. The free space information impacts viable tilt directions.
Mushroom Height—Taller mushrooms always get picked first as they can generally be picked without causing damage to neighbouring, shorter mushrooms.

The planning system 110 uses some different parameters to determine the picking schedule when the end effector 106B is used compared to when end effector 106A is used. This is because, relative to the belt and cup mechanism of end effector 106A, the vacuum cup end effector 106B requires less clearance space and direction to function, making it more malleable and allowing for more flexibility across flush conditions. As noted above, the parameters used to determine the picking schedule for end effector 106B include mushroom radius, free space around the mushroom to apply the tilting motion, and mushroom height. Radius is used to enable certain sizes of mushrooms to be picked first (e.g. larger mushrooms first). Free space refers to the space around a mushroom that does not contain any obstacles, such as other mushrooms. The amount of free space indicates whether the preferred direction of tilt can be used, or whether other viable (but less preferred) tilt directions can be used. Height is used because taller mushrooms are generally picked first, as picking shorter mushrooms in a cluster first could cause damage to neighbouring mushrooms.

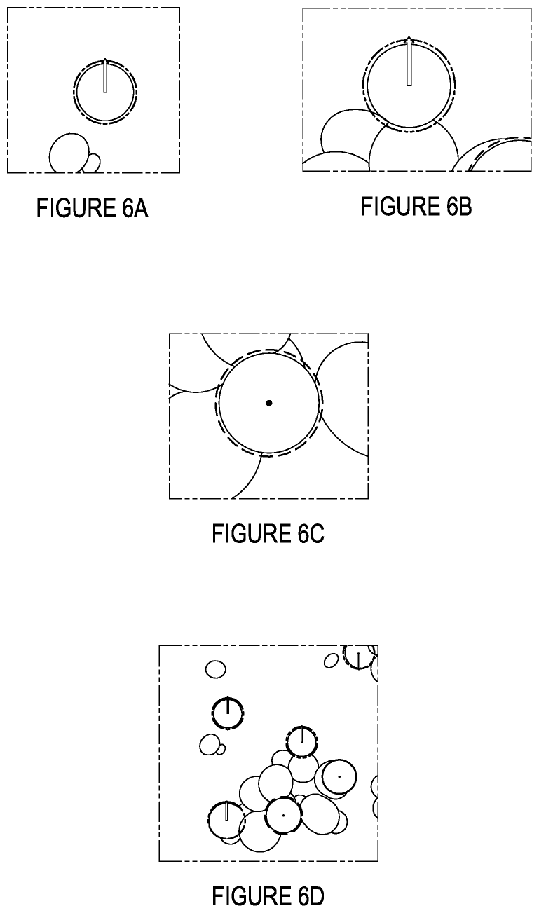

FIGS. 6A to 6D show how the categorisation is performed for end effector 106B. FIG. 6A shows a category 1 mushroom, which can be picked first, FIG. 6B shows a category 2 mushroom that can be picked after at least one other obstructing mushroom has been picked, and FIG. 6C shows a category 3 mushroom that cannot currently be picked. FIG. 6D shows the categorisation of various mushrooms in a mushroom bed.

The free space calculation is made by checking the free space in four directions i.e. 0°, 90°, 180° and 270°. Additional tilt directions may be used to increase the degrees of freedom when deciding which mushroom to pick. The free space verification is done by checking the contents of the space in the direction being queried (one of the four angles above) by taking the centre point of a mushroom and then adding its radius/2 and the necessary clearance space (which in certain configurations of end effector 106B, may be 3.5 mm). This is then converted from millimetres to pixels. If the space is empty, then this mushroom gets added to the category 2 list. It is at this stage in the process that the height check using the RGB-D camera is done to choose a category 1 target to publish.

In this picking schedule, category 1 is reserved for the first mushroom to be picked. It is demonstrated as an overlay/bounding box (e.g. a circular green overlay) over the position of the mushroom with an arrow in the centre of the overlay depicting the available tilt direction that will create minimal damage to the surrounding areas when the mushroom is picked. In this case, there is only one category 1 mushroom displayed at a time, as this is the mushroom that satisfies all previously mentioned heuristics of radius, free space and height.

A category 2 mushroom is shown in FIG. 6B. All mushrooms in category 2 have the potential to be immediately picked and classed as category 1. However, the depth information obtained from the vision system may be used to determine which mushroom will become category 1 when the existing category 1 mushroom has been picked. For example, the tallest mushroom in category 2 may be changed to category 1 after the existing category 1 mushroom has been picked. This process is constantly being repeated until no mushrooms are left to pick.

Category 3 mushrooms are mushrooms that cannot currently accommodate tilting procedures due to the surrounding areas, whether this is because of nearby mushrooms, or because the image only shows part of the mushroom (as it appears near the edge of the image) such that it is unclear whether the mushroom can be tilted or picked without damaging other mushrooms. As shown in FIG. 6C, an overlay/bounding box (e.g. a black circle) may be provided over category 2 mushrooms. The overlay may change when the constraints that deter them from becoming category 1 are removed. This may occur when nearby mushrooms have been picked.

Thus, for the end effector of FIGS. 3A and 3B, determining a picking schedule based on the radius of the cap, the height and the amount of free space in the vicinity of each mushroom may comprise categorising each mushroom into: a first category representing a tallest mushroom and first mushroom to be picked; a second category representing mushrooms that can be picked immediately after the first mushroom has been picked; or a third category representing mushrooms that cannot currently be picked. The categorisation may be performed after filtering the mushrooms based on whether the radius of the cap is within a predefined range. Additionally or alternatively, the categorisation may be performed after filtering the mushrooms based on whether there is sufficient free space in the vicinity of each mushroom to enable it to be picked. Thus, the picking schedule generally schedules taller mushrooms to be picked before shorter mushrooms, and in each picking round may pick the tallest mushroom first, as the tallest mushroom may be pickable without damaging surrounding mushrooms.

### Training the Neural Network

As mentioned above, a neural network 114 of the vision system 108 is used to determine the pose or orientation of each mushroom. As pose/orientation estimation involves modelling a regression task, the neural network 114 is based around a residual neural network (ResNet). The outputs of the neural network 114 have been adjusted to be a regression task resulting in quaternion or Euler angles.

The training data used to train the neural network 114 comprises images of a mushroom bed (or of portions/areas within a mushroom bed). Images of mushrooms in a mushroom bed are collected once a day for three days. This is to maximise data collection before the mushrooms naturally deteriorate to a point that they cannot be usefully used for computer vision tasks. At the same time, the orientation of a target mushroom within the mushroom bed (and collected images) is captured. In this way, there is a labelled image of each target mushroom, where the image is labelled with orientation information.

Images are captured by moving the robotic arm 102 to a position over the mushroom bed to enable imaging device 112 to capture an image of entire mushroom bed.

A process to identify mushrooms within the captured image may be implemented. This may be similar to the process described above with respect to identifying and segmenting mushrooms. A randomly-selected mushroom may then be selected and displayed on a display screen of a computing device performing this process. The robotic arm 102 may be moved to be vertical on the targeted mushroom cap surface/plane. This enables the exact position (global coordinates) of each joint of the robotic arm to be captured. The global coordinates of the robotic arm, the global coordinates of the selected mushroom, and the radius of the selected mushroom can be captured and stored. This process is repeated for each mushroom within the mushroom bed. This information enables the mushroom orientation to be determined for each mushroom.

The training of the neural network 114 is performed using the collected images and data. Segmented versions of the collected images may be used. The neural network 114 is trained to minimise the angle between the ground truth and the predicted quaternions.

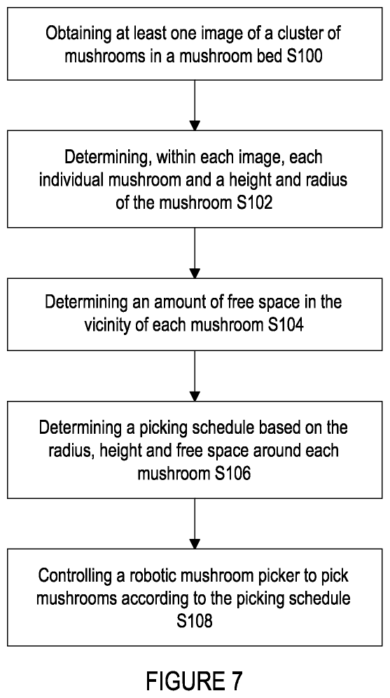

FIG. 7 is a flowchart of example steps to pick mushrooms using a robotic mushroom picking system. The method comprises obtaining at least one image of a cluster of mushrooms in a mushroom bed (step S100). Obtaining at least one image may comprise obtaining at least one image captured by an RGB-D camera/sensor (i.e. a red-green-blue-depth camera or sensor). The RGB-D camera may enable a three-dimensional map of the mushroom bed or a portion of the mushroom bed to be generated.

The method comprises determining, within each image: each individual mushroom, a height of each individual mushroom, and a radius of a cap of each individual mushroom (step S102). The determining step may comprise performing image segmentation to generate image segments, wherein each image segment contains an individual mushroom. This may be useful because it may be easier for the pose estimation to be performed (by the trained neural network) based on images of individual images.

The method comprises determining an amount of free space in the vicinity of each mushroom (step S104) as explained above. This is used to determine whether there is sufficient space for the end effector to harvest the mushroom, and sufficient space for the mushroom to be moved during the harvesting process (e.g. pushed-pulled for end effector 106A, or tilted and twisted for end effector 106B).

The method comprises determining a picking schedule based on the radius of the cap, the height and the amount of free space in the vicinity of each mushroom (step S106). Determining a picking schedule based on the radius of the cap, the height and the free space of each mushroom may depend on the specific geometry and functionality of the end effector used for the harvesting, as explained above in more detail.

The method may comprise controlling the robotic mushroom picker to pick mushrooms according to the picking schedule (step S108). Controlling the robotic mushroom picker to pick mushrooms may comprise controlling an orientation of the robotic mushroom picker to pick each mushroom based on a corresponding preferred pick direction in the picking schedule.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A computer-implemented method for picking mushrooms from a mushroom bed with a robotic mushroom picker, the method comprising:
obtaining at least one image of a cluster of mushrooms in a mushroom bed;
determining, within each image:
each individual mushroom,
a position and a height of each individual mushroom, and
a radius of a cap of each individual mushroom;
determining an amount of free space in the vicinity of each mushroom;
determining a picking schedule based on the radius of the cap, the height and the amount of free space in the vicinity of each mushroom; and
controlling the robotic mushroom picker to pick mushrooms according to the picking schedule.

2. The method as claimed in claim 1 further comprising:
updating, after the picking of a mushroom, the determined picking schedule based on any changes to remaining mushrooms in the cluster of mushrooms after picking.

3. The method as claimed in claim 1 wherein obtaining at least one image comprises obtaining at least one image captured by an RGB-D camera.

4. The method as claimed in claim 1 wherein identifying, within each image, each individual mushroom comprises performing image segmentation to generate image segments, wherein each image segment contains an individual mushroom and wherein the method further comprises estimating a pose of each identified individual mushroom by:
inputting each image segment into a trained neural network; and
predicting, using the trained neural network, a quaternion or Euler representation of a rotation of each mushroom.

5. (canceled)

6. The method as claimed in claim 1 wherein determining a picking schedule based on the radius of the cap, the height and the amount of free space in the vicinity of each mushroom comprises categorising each mushroom into:
a first category representing mushrooms that can be picked immediately in a preferred pick direction,
a second category representing mushrooms that can be picked in a preferred pick direction after at least one obstructing mushroom has been picked, or
a third category representing mushrooms that cannot be picked in a preferred pick direction without interfering with another third category mushroom.

7. The method as claimed in claim 1 wherein determining a picking schedule based on the radius of the cap, the height and the amount of free space in the vicinity of each mushroom comprises categorising each mushroom into:
a first category representing a tallest mushroom and first mushroom to be picked;
a second category representing mushrooms that can be picked immediately after the first mushroom has been picked; or
a third category representing mushrooms that cannot currently be picked.

8. The method as claimed in claim 1 wherein controlling the robotic mushroom picker to pick mushrooms comprises controlling an orientation of the robotic mushroom picker to pick each mushroom based on a corresponding preferred pick direction in the picking schedule.

9. A robotic mushroom picker comprising:
a robotic arm and a robotic end effector coupled to the robotic arm;
a vision system for:
obtaining at least one image of a cluster of mushrooms in a mushroom bed;
determining, within each image each individual mushroom, a height of each individual mushroom, and a radius of a cap of each individual mushroom; and
determining an amount of free space in the vicinity of each mushroom;
a planning system for determining a picking schedule based on the radius of the cap, the height and the amount of free space in the vicinity of each mushroom as determined by the vision system; and
a control system for controlling the robotic arm and robotic end effector to pick mushrooms according to the picking schedule.

10. The robotic mushroom picker as claimed in claim 9 wherein the vision system comprises an RGB-D camera and wherein the vision system is further configured to estimate a pose of each identified individual mushroom.

11. (canceled)

12. The robotic mushroom picker as claimed in claim 9 wherein controlling the robotic mushroom picker to pick mushrooms comprises controlling an orientation of the robotic mushroom picker to pick each mushroom based on a corresponding preferred pick direction in the picking schedule.

13. The robotic mushroom picker as claimed in claim 9 wherein the robotic end effector comprises a perforated belt and a vacuum cup coupled to a vacuum source.

14. The robotic mushroom picker as claimed in claim 13 wherein controlling the robotic arm and robotic end effector comprises:
pressing the perforated belt of the end effector onto a cap of a mushroom;
driving the perforated belt in a first direction to break a stem of the mushroom;
driving the perforated belt in a second direction to return the mushroom to a centre of the robotic end effector;
driving the vacuum cup onto a portion of the perforated belt that is pressed onto the cap of the mushroom; and
supplying negative air pressure to the vacuum cup, thereby gripping the mushroom by the perforated belt and vacuum cup.

15. The robotic mushroom picker as claimed in claim 13 wherein determining a picking schedule comprises categorising each mushroom into:
a first category representing mushrooms that can be picked immediately in a preferred pick direction,
a second category representing mushrooms that can be picked in a preferred pick direction after at least one obstructing mushroom has been picked, or
a third category representing mushrooms that cannot be picked in a preferred pick direction without interfering with another third category mushroom.

16. The robotic mushroom picker as claimed in claim 9 wherein the robotic end effector comprises a vacuum cup, and wherein the vacuum cup comprises:
a plurality of vacuum distribution channels on an inner surface of the vacuum cup, extending between a vacuum transfer port and an outer edge of the suction cup; and
a plurality of protrusions on an inner surface of the vacuum cup for gripping a mushroom.

17. The robotic mushroom picker as claimed in claim 16 wherein controlling the robotic arm and robotic end effector comprises:
driving the vacuum cup onto a cap of a mushroom;
supplying negative air pressure to the vacuum cup, for retaining a portion of the cap of the mushroom in the vacuum cup; and
rotating the vacuum cup while a portion of the cap of the mushroom is retained in the vacuum cup, to break a stem of the mushroom.

18. The robotic mushroom picker as claimed in claim 17 wherein determining a picking schedule based on the radius of the cap, the height and the amount of free space in the vicinity of each mushroom comprises categorising each mushroom into:
a first category representing a tallest mushroom and first mushroom to be picked;
a second category representing mushrooms that can be picked immediately after the first mushroom has been picked; or
a third category representing mushrooms that cannot currently be picked.

19. The robotic mushroom picker as claimed in claim 17 wherein controlling the robotic arm and robotic end effector further comprises:
moving the vacuum cup to tilt the mushroom to be substantially vertical, when the picking schedule indicates that the mushroom is at an angle to the vertical direction.

20. The robotic mushroom picker as claimed in claim 16 wherein the vacuum cup is releasably coupled to the robotic end effector.

21. The robotic mushroom picker as claimed in claim 9 wherein the planning system updates the picking schedule after a mushroom has been picked.

22. (canceled)

23. (canceled)

24. A robotic end effector couplable to a robotic arm for picking, harvesting or lifting fragile objects, the robotic end effector comprising:
a vacuum cup couplable to a vacuum source, the vacuum cup comprising:
a plurality of vacuum distribution channels on an inner surface of the vacuum cup, extending between a vacuum transfer port and an outer edge of the vacuum cup; and
a plurality of protrusions on an inner surface of the vacuum cup for gripping the fragile object.

25. (canceled)
